(19) United States
(12) Patent Application Publication
(10) Pub. No.: US 2026/0196886 A1
(43) Pub. Date: Jul. 9, 2026

(54) ELECTRIC MACHINE COOLING

(71) Applicant: FCA US LLC, Auburn Hills, MI (US)

(72) Inventors: Karunakar Yedam, Auburn Hills, MI (US); Dhafar Al-Ani, Auburn Hills, MI (US)

(21) Appl. No.: 19/013,205

(22) Filed: Jan. 8, 2025

(51) Int. Cl. H02K 1/20; H02K 1/276; H02K 1/32; H02K 3/24; H02K 3/34; H02K 7/00

(52) U.S. Cl. CPC H02K 1/20; H02K 1/276; H02K 1/32; H02K 3/24; H02K 3/345; H02K 7/003

(57) ABSTRACT

An electric machine includes a rotor assembly having a plurality of permanent magnets disposed within a rotor core. A stator assembly includes a stator core with a first end and an opposite second end, a plurality of radially aligned slots formed in the stator core and defining a plurality of radially aligned teeth, a sleeve disposed in each slot of the plurality of radially aligned slots, and conductive windings wound on the plurality of teeth and extending through the sleeves. A flow of coolant is directed through each sleeve for cooling of the conductive windings between the first and second ends of the stator core.

### FIELD

The present application generally relates to electric machines and, more particularly, to an electric machine thermal system for improved cooling.

### BACKGROUND

Electric machines, such as electric traction motors, generate heat during operation, particularly in electric steel laminations, copper conductors, and permanent magnets. Exceeding the thermal limits of the electric machine components affects both electromagnetics and thermal performance, efficiency, reliability, and durability. Therefore, it is critical to provide quick and sustained cooling strategies for such components in order to meet specific technical requirements needed for all vehicle operating conditions. Conventional cooling solutions include water jackets, oil cooling, or a combination thereof. However, such solutions may be located far from the heat source and fail to cool the permanent magnets in the rotor domain and potentially cause demagnetization. Accordingly, while such systems work well for their intended purpose, there exists an opportunity for improvement in the relevant art.

### SUMMARY

According to one example aspect of the invention, an electric machine is provided. In one exemplary implementation, the electric machine includes a rotor assembly having a plurality of permanent magnets disposed within a rotor core. A stator assembly includes a stator core with a first end and an opposite second end, a plurality of radially aligned slots formed in the stator core and defining a plurality of radially aligned teeth, a sleeve disposed in each slot of the plurality of radially aligned slots, and conductive windings wound on the plurality of teeth and extending through the sleeves. A flow of coolant is directed through each sleeve for cooling of the conductive windings between the first and second ends of the stator core.

In addition to the foregoing, the described electric machine may include one or more of the following features: wherein each sleeve includes a frame that defines a passage configured to receive the conductive windings and the flow of coolant; wherein each sleeve extends an entire axial length of the stator core; wherein each sleeve is fabricated from an insulating material configured to electrically separate the conductive windings and the stator core; and wherein each sleeve is configured to replace insulation paper such that the stator assembly does not include insulation paper wrapped around the conductive windings.

In addition to the foregoing, the described electric machine may include one or more of the following features: wherein each sleeve includes a frame that defines a passage configured to receive the conductive windings, and a plurality of individual coolant conduits extending through the passage, wherein each individual coolant conduit is configured to receive a portion of the flow of coolant therethrough for cooling the conductive windings extending through the passage; wherein each individual coolant conduit is enclosed such that the flow of coolant provides indirect cooling to the conductive windings; and wherein each individual coolant conduit includes one or more apertures along an axial length thereof, wherein the one or more apertures allow coolant to flow into the passage for direct cooling of the conductive windings.

In addition to the foregoing, the described electric machine may include one or more of the following features: wherein each conductive winding includes a pair of the individual coolant conduits disposed on opposite sides of the conductive winding; wherein the stator assembly further includes at least one coolant channel formed in each radially aligned tooth, wherein each coolant channel extends between the stator core first and second ends and is configured to receive at least a portion of the coolant flow; and wherein the at least one coolant channel includes a first rectangular slotted aperture disposed adjacent to the radially aligned slot on a first side of the radially aligned tooth, and a second rectangular slotted aperture disposed adjacent to the radially aligned slot on an opposite second side of the radially aligned tooth.

In addition to the foregoing, the described electric machine may include one or more of the following features: wherein the at least one coolant channel has a first length, and each slot has a second length, wherein the first length is substantially equal to the second length; wherein the at least one aperture is an elliptical aperture disposed equidistant between the slots on either side of the radially aligned tooth; wherein the rotor assembly further includes a plurality of coolant passages extending between opposite first and second ends of the rotor core and configured to receive a second flow of coolant for cooling of the rotor assembly.

In addition to the foregoing, the described electric machine may include one or more of the following features: wherein the coolant passages are arranged circumferentially about an outer diameter of the rotor core; wherein the plurality of permanent magnets includes adjacent pairs of permanent magnets oriented in a V-configuration; wherein each coolant passage is located centrally of one of the V-configurations radially outward thereof; and an output shaft coupled for rotation with the rotor core, wherein the output shaft includes one or more shaft coolant distribution passages fluidly coupled to the plurality of coolant passages.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a schematic view of an example electric machine and thermal system therefor, in accordance with the principles of the present application;

FIG. 2 is a side cross-sectional view of one embodiment of the electric machine shown in FIG. 1, in accordance with the principles of the present application;

FIG. 3 is a schematic view of an example stator configuration that may be utilized with the electric machine shown in FIG. 1, in accordance with the principles of the present application;

FIG. 4 is a cross-sectional view of an example insulative sleeve that may be utilized with a stator assembly of the electric machine shown in FIG. 1, in accordance with the principles of the present application;

FIG. 5 is a side cross-sectional view of a stator assembly having a plurality of the insulative sleeves shown in FIG. 4, in accordance with the principles of the present application; and

FIG. 6 is an end view of the stator assembly shown in FIG. 5, in accordance with the principles of the present application.

### DESCRIPTION

Electric machines are widely used in the automotive industry to propel vehicles with electrified powertrains, such as plug-in hybrid electric vehicles (PHEVs), fuel cell vehicles (FCVs), hydrogen with hybrid internal combustion engine (H2-ICE) vehicles, and battery electric vehicles (BEVs). As previously described, high temperatures produced during operation of the electric machines may adversely affect performance and efficiency and limit torque and power production. As such, it is desirable to quickly remove heat from the system since increased heat dissipation enables the electric machine to produce more power and torque. Accordingly, described herein are systems and methods of manufacturing electric machines, such as electric traction motors, with a thermal system to improve cooling and overall performance.

In one example, routing in the stator domain enables oil to flow in contact with a heat source through a front channel, travel through a sleeve disposed in the stator teeth. Spacers create a swirl flow around copper wires/layers (conductors) in straight sections and exit from a rear channel to mitigate heat efficiently. The spacers are made of an insulating material (e.g., ceramic/composite/plastic) placed between the copper conductors to avoid direct contact to prevent short circuiting. The spacers are disposed along the winding configuration with purposefully designed gaps/clearances in the stator region.

In the rotor domain, the rotation of the rotor causes induced pressure-rise due to high centrifugal effects. The pressure difference drives the oil to travel through the rotor end caps/plates and through channels near the air gap. At the exits, the end channels are designed in a unique way to balance with centripetal force and allow oil to travel towards the shaft with less restriction in the electric machine (e.g., centrifugal force is equal to centripetal force). In this way, the oil circuit becomes a closed loop and avoids oil spill to dissipate heat without oil intrusion within the stator and rotor domains (e.g., no oil intrusion into the air gap).

In the example embodiment, channeling oil through enclosed circuits in the stator and rotor domains is configured to void oil intrusion in the air gap, thereby mitigating drag loss at all speeds and allowing a quick oil temperature rise with efficient overall heat transfer between adjacent components, the stator laminations and the rotor laminations/magnets in the electric machine.

The design also eliminates conventional insulation paper by replacing it with a sleeve made with insulation material. The spacer is disposed in the stator slot region and is configured to guide oil/e-fluid between the copper conductors to achieve a 100% wetted surface in the end-windings and in straight sections. This wetted surface leads to improved cooling efficiency and minimizes overall heat transfer coefficients (HTCs) variation at all operating speeds. Further, the magnitude of the HTCs generated are independent to electric machine operating speeds, which makes the cooling strategy robust in meeting component temperature limits at critical vehicle driving cycles.

Because cooling fluids like oil or engineered e-fluids (less viscous fluid) are circulating the varnish coated copper conductor outer perimeter, additional exposed surface area is available to dissipate heat. The cooling fluid can travel in slots parallel to the copper conductors. As the cooling fluid is in direct contact with the copper conductors in the stator domain and additionally flowing across the rotor domain, all three modes of heat transfer (conduction, convection, and radiation) and non-linear heat transfer interactions in the stator and rotor domains are present at all speeds and allow the electric machine to produce more than 75% of peak power and torque at continuous operating conditions.

The system described herein provides advantages. First, the design allows oil to travel through channels and sleeves in the stator slots (i) in direct contact with the coated copper conductors tortuous oil path, (ii) between the stator slots, or (iii) within hollow copper conductors. Second, oil is allowed to pass through perforations at both the inlet and outlet sides of the end windings. Third, the spacers/braces replace conventional insulation paper and can be made of an insulation material such as, for example, plastic, composite, metal, glass, wood, etc. The spacers/braces may be installed using any suitable method such as, for example, clipping, pressing, gluing, fitting, capping, etc.

Accordingly, the electric machines described herein provide a spill-proof design that flows cooling fluid in direct contact with copper conductors in the stator domain as well as across the rotor domain. In some embodiments, the cooling fluid paths allow the electric machine to reach a continuous torque target≥70-80% of the peak torque and overall maximum efficiency up to 96%, while also using the use of less expensive rare-earth magnets. Furthermore, simplifying simulation complexities with single phase flow with transient multiple reference frame (MRF) or sliding mesh motion (SMM) vs. complex volume of fluid (VOF) to discrete phase model (DPM) to VOF multiphase flows (air+oil) using transient SMM results, will achieve quick turnaround on wall-times during development cycles.

With the cooling fluid distribution strategy described herein, the cooling fluid adheres to the external skin (e.g., enamel coating) of the copper conductors and provides a fully wetted surface in both tightly packed end-windings and in stator core slots. In this way, the cooling fluid interacts with the adjacent walls of the stator core and rotor stack heat sources for effective heat transfer and dissipates heat. Similarly, cooling fluid circulation due to centrifugal, centripetal, and fluid-dynamic forces in the rotor domain mitigate any hot spots residing near the magnets and air gap in the middle of the rotor region. In general, the electric machine provides efficient stator and rotor thermal management using an engineered coolant (e-fluid) or oil (e.g., automatic transmission fluid), generally referred to herein as coolant.

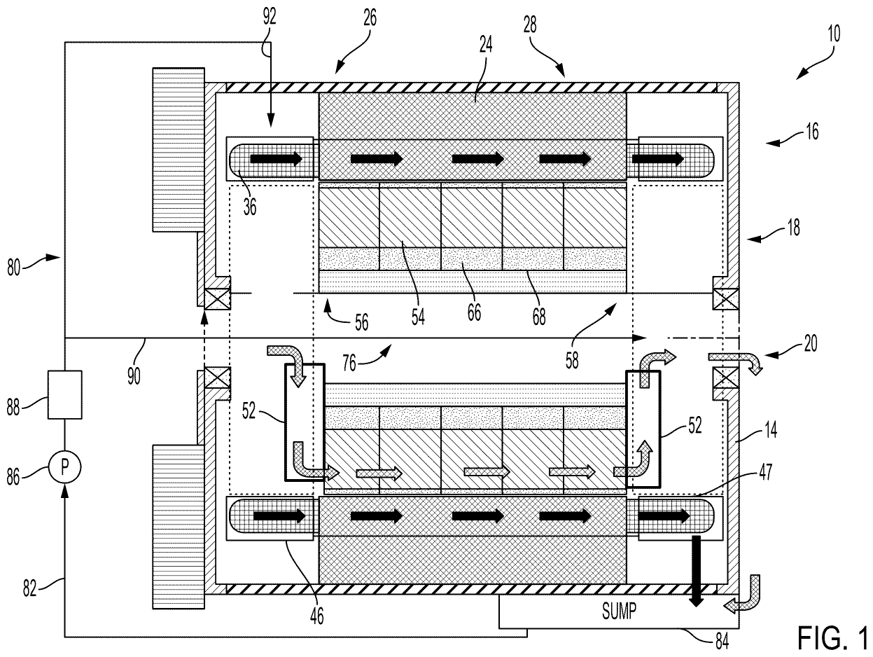

Referring now to FIG. 1, a schematic cross-section of an example electric machine is illustrated and generally identified at reference numeral 10. In the example embodiments, electric machine 10 is described as an electric traction motor for an electric vehicle, but it will be appreciated that the features described herein may be applied to various electric machines. In general, electric machine 10 includes a thermal system 12 configured to provide increased heat transfer and thereby rapidly cool the electric machine 10 to improve torque, power, and efficiency. However, it will be appreciated that due to the increased heat transfer capability, the thermal system 12 may also rapidly heat the electric machine 10 to improve performance in low temperature conditions (e.g., below 0° C.).

In the illustrated example, electric machine 10 generally includes a housing 14 containing a stator assembly 16 operably associated with a rotor assembly 18 and an output shaft 20. In general, the stator assembly 16 receives electrical power to produce a magnetic field, which interacts with a magnetic field of the rotor assembly 18 to produce mechanical power to the shaft 20.

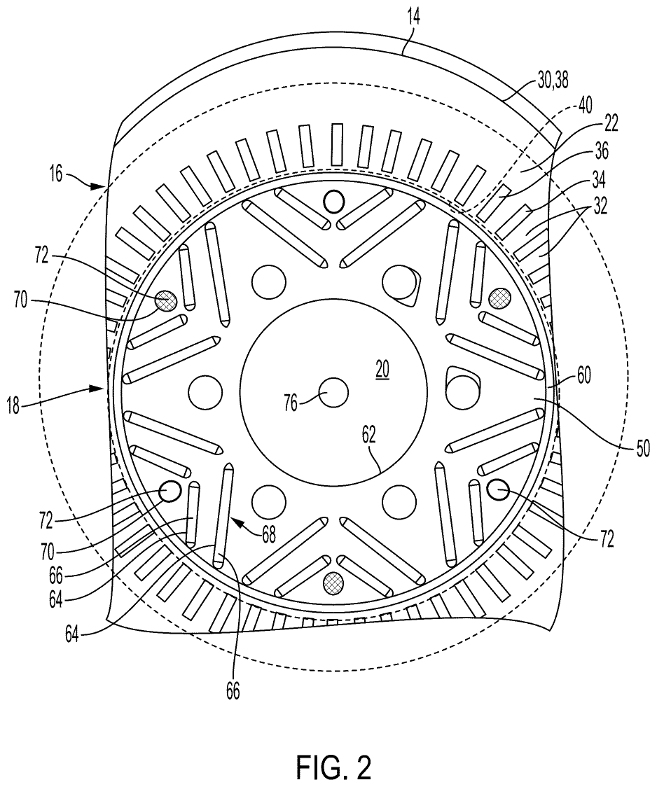

With additional reference to FIG. 2, in the example embodiment, stator assembly 16 is formed from a plurality of individual annular stator laminations 22 (only one shown). The stator laminations 22 are stacked one on top of the other to a length known as the stack length, which determines the torque and power output of the electric machine 10. The stator laminations 22 are coupled together, for example, by bonding, gluing, interlocking, welding, or other suitable joining technique to form a stator core or stack 24 having a first end 26 and an opposite second end 28 (FIG. 1). The number of stator laminations 22 of the stack 24 can be based on design considerations and, as such, stator assembly 16 may have any suitable number of stator laminations 22. Alternatively, the stator core may be a solid structure rather than formed from laminations.

In the illustrated example, each stator lamination 22 is fabricated from an electric steel in a punching die, laser cut, 3D printing, etc. (not shown) to produce a generally annular component (partially shown) having a back iron 30 with a plurality radially aligned teeth 32 extending radially inward from the back iron 30. The stator teeth 32 define slots 34 therebetween through which coil windings 36 are wound. The back iron 30 defines an outer diameter 38, and the distal end of each stator tooth 32 defines an inner diameter edge 40. As described herein in more detail, each slot 34 includes a sleeve 100 configured to receive the coil windings and a flow of coolant.

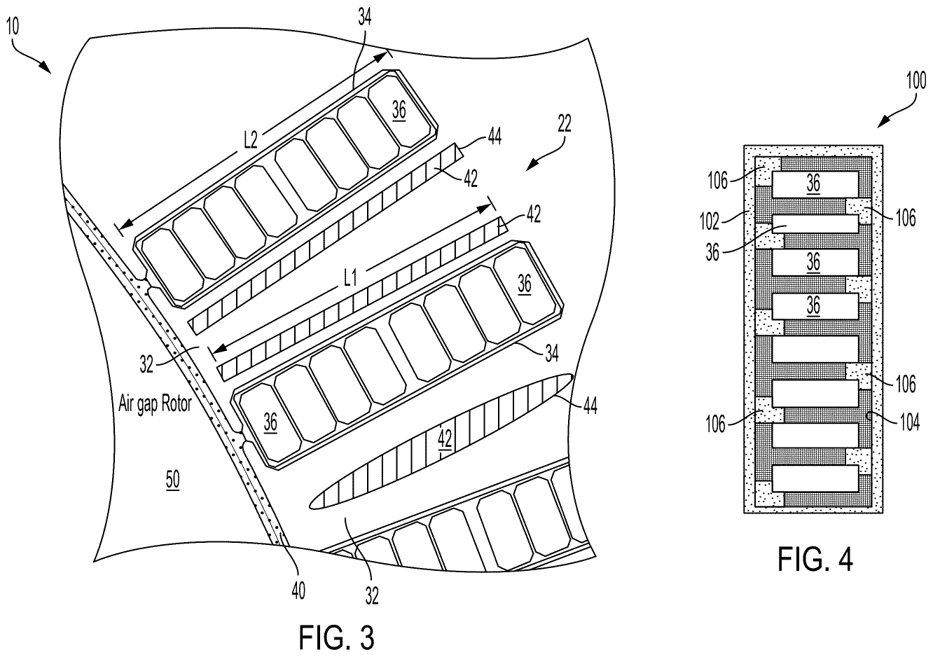

As shown in FIG. 3, in some configurations, each stator lamination 22 is formed with a plurality of slotted or elliptical apertures 42 in each stator tooth 32. For example, each tooth 32 may include a pair of rectangular slotted apertures 42 which are formed parallel to their adjacent slot 34, or a single elliptical aperture 42 located equidistant between adjacent slots 34. As illustrated, the apertures 42 have a length ‘L1’ that is equal to or approximately equal to the entire height/length ‘L2’ of the stator slot 34, which receives the coil windings 36. In one example embodiment, it is critical that ‘L1’ is equal to or approximately equal to ‘L2’ in order to provide the proper amount of cooling to the stator assembly 16.

During assembly, the stator laminations 22 are stacked such that the apertures 42 are aligned to define a channel 44 through the stacked configuration. As will be described in more detail, each channel 44 is configured to receive a flow of coolant in a first direction from the stator first end 26 to the second end 28, or in an opposite second direction from the stator second end 28 to the first end 26. In the illustrated example, channels 44 are arranged between slots 34 to be in close proximity to the heat generating windings 36 and provide improved cooling thereto. However, it will be appreciated that channels 44 may be located in various other locations in the stator lamination 22 and have any desired number of channels 44.

With continued reference to FIG. 1, the stack of stator laminations 22 are disposed between a pair of manifolds or inlets 46, 47. Each inlet 46, 47 defines a coolant channel 48, which is fluidly connected to an inlet of the individual stator coolant channels 44 for circulating the coolant therethrough. As such, the inlet coolant channels 48 receive a supply of coolant, which is subsequently supplied to the stator coolant channels 44. The front inlet 46 is disposed at the stator first end 26 and is fluidly coupled to a first portion of the channels 44 to supply coolant in the first direction from the first end 26 to the second end 28. The rear inlet 47 is disposed at the second end 28 and is fluidly coupled to a second portion of the channels 44 to supply coolant in the second direction from the second end 28 to the first end 26. In this way, a flow of colder coolant is supplied at each end 26, 28 to evenly distribute cooling across the stator assembly 16.

Referring now to FIGS. 4-6, in one example embodiment, each stator slot 34 includes the sleeve 100. The sleeve 100 generally includes an insulated frame 102 that extends the entire axial length of the stator stack 24. In this way, frame 102 defines an enclosure or passage 104 configured to receive the coil windings 36 (or other conductor). The insulated frame 102 is fabricated from an insulating material (e.g., ceramic, plastic, etc.) to separate the conductor 36 and the metallic stator laminations 22. Advantageously, the sleeve 100 is configured to replace conventional insulation paper, which is typically wrapped around the coils/conductors, without affecting the conductor/winding filling factor (i.e., how much conductor/winding fills the stator slot 34).

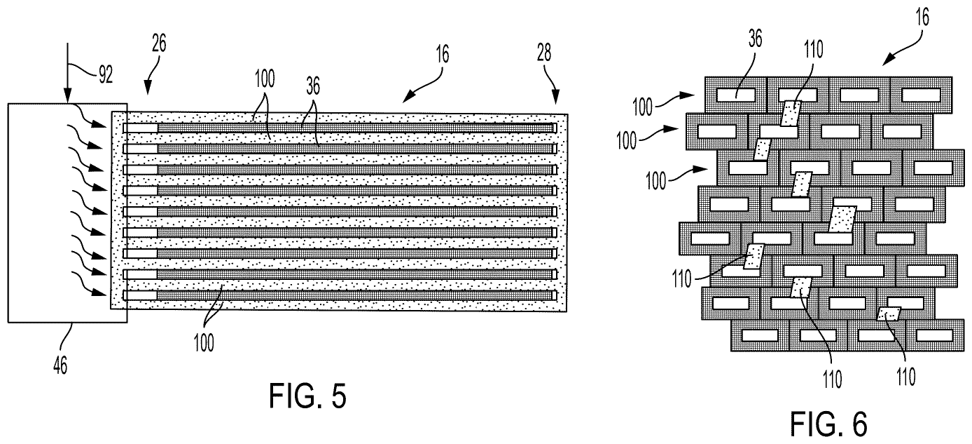

Each sleeve 100 is configured to receive a flow of coolant from the front inlet 46 or the rear inlet 47. In this way, as shown in FIG. 5, coolant flows through passage 104 between the stator first and second ends 26, 28 in direct contact with the conductors 36 to absorb thermal energy and provide cooling thereto. In an additional or alternative embodiment, each sleeve 100 includes a plurality of individual coolant conduits 106 (FIG. 4) coupled to the interior of frame 102 and which extend inwardly into the passage 104 that receives conductors 36. Each individual coolant conduit 106 receives a flow of coolant from the front inlet 46 or the rear inlet 47 and supplies coolant between the stator first and second ends 26, 28.

In one example, the individual coolant conduits 106 are enclosed to provide indirect heat exchange with the conductors. In another example, the individual coolant conduits 106 include one or more apertures or perforations (not shown) along their axial length to allow coolant to flow into the passage and into direct contact with the conductors 36 for cooling thereof. When in direct contact, the coolant causes the outer surface of the conductors 36 to be wetted to improve cooling efficiency and minimize overall HTC variations at all operating speeds. In the illustrated example, a pair of individual coolant conduits 106 are disposed on opposite sides of each conductor 36 to facilitate providing coolant across the entire conductor 36.

FIG. 6 illustrates a side view of a portion of an end 26, 28 of the stator stack 24 with a plurality of sleeves 100. This illustrates the area of stator assembly where the end windings of conductors 36 are present. In the example embodiment, a plurality of clips/spacers 110 is configured to maintain copper end-windings tolerances between copper layers.

With continued reference to FIG. 2, in the example embodiment, the rotor assembly 18 is formed from a plurality of individual annular rotor laminations 50 (only one shown) with a pair of opposed short-circuit rings or end caps 52 (FIG. 1). The rotor laminations 50 are stacked one on top of the other to a stack length, which further determines the torque and power output of the electric machine 10. The rotor laminations 50 are coupled together, for example, by bonding, gluing, interlocking, welding, or other suitable joining technique to form a rotor core or stack 54 having a first end 56 and an opposite second end 58. The number of rotor laminations 50 of the stack 54 can be based on design considerations and, as such, rotor assembly 18 may have any suitable number of rotor laminations 50. Alternatively, the rotor core may be a solid structure rather than formed from laminations.

In the illustrated example, each rotor lamination 50 is fabricated from an electric steel in a punching die, laser cut, 3D printing, etc. (not shown) to produce a generally circular or annular component having an outer diameter 60, an inner diameter 62, and a plurality of slots or apertures 64 for receiving one or more permanent magnets 66. The outer diameter 60 faces the stator inner diameter edge 40, and the inner diameter 62 receives and is mechanically coupled (e.g., splined) to the shaft 20. During assembly, the rotor laminations 50 are stacked such that the apertures 64 are aligned to define passages 68 for the permanent magnets 66. In the example embodiment, the adjacent pairs of permanent magnets 66 are oriented in a V-configuration.

Additionally, as shown in FIG. 2, each rotor lamination 50 is formed with a plurality of second apertures 70. During assembly, the rotor laminations 50 are stacked such that the second apertures 70 are aligned to define coolant channels or passages 72 through the stacked configuration. As will be described in more detail, each coolant passage 72 is configured to receive a flow of coolant in the first direction from the rotor first end 56 to the second end 58, or in the opposite second direction from the rotor second end 58 to the first end 56. In the illustrated example, coolant passages 72 are arranged generally circumferentially about the rotor outer diameter 60 and in close proximity to the heat generating permanent magnets 66 to provide improved cooling thereto. In the illustrated example, the coolant passages 72 are located centrally of the V-configuration of the permanent magnets 66 and radially outward thereof near the outer diameter 60. However, it will be appreciated that passages 72 may be located in various other locations in the rotor lamination 50 and have any desired number of passages 72.

With continued reference to FIG. 1, the stack 54 of rotor laminations 50 is disposed between the opposed end caps 52. Each end cap 52 is fluidly connected to the coolant passages 72 for circulating the coolant therethrough. The end caps 52 are fluidly coupled to the output shaft 20 to receive a flow of coolant therefrom or provide the flow of coolant thereto. As shown in FIGS. 1 and 2, the shaft 20 includes one or more coolant distribution passages 76 configured to receive a flow of coolant. As such, the shaft coolant distribution passages 76 supply coolant to the end caps 52 (which may include one or more coolant passages of their own, not shown), which subsequently supply the coolant to the individual coolant passages 72.

With continued reference to FIG. 1, the thermal system 12 will be described in more detail. In the example embodiment, the thermal system 12 generally includes a coolant loop or circuit 80 that includes a main conduit 82 configured to receive heated coolant from the electric machine 10, for example, via a sump 84 of the housing 14. A pump 86 circulates the coolant through coolant circuit 80 such that heated coolant from sump 84 is directed to a heat exchanger 88 for cooling of the heated coolant.

A first portion of the cooled coolant is then directed through a first conduit 90 fluidly coupled to the shaft coolant distribution passages 76. A second portion of the cooled coolant is directed through a second conduit 92 to provide coolant to the stator front inlet 46, which subsequently provides the coolant through stator coolant channels 44 and/or insulated sleeves 100.

The first portion of coolant in first conduit 90 is directed to the shaft coolant distribution passage(s) 76, which are formed in the output shaft 20. The first portion of coolant then flows to the front end cap 52, and subsequently into the rotor coolant passages 72. The first portion of coolant flows from one end cap 52 toward the opposite end cap 52 while absorbing heat from the rotor assembly 18 and permanent magnets 66. Upon reaching the opposite side of the rotor assembly 18, the first portion of coolant is directed through the opposite rear end cap 52 and back into the rotor coolant passage(s) 72 of output shaft 20, as shown in FIG. 1. The first portion of coolant then drains to the sump 84 and is returned to pump 86 to repeat the cycle.

A second portion of coolant from heat exchanger 88 is circulated through coolant circuit 80 to conduit 92 and into the stator front inlet 46. Coolant is then directed through the stator coolant channels 44 and/or the insulated conductor sleeves 100 fluidly coupled thereto. The coolant flows in stator coolant channels 44 and/or the insulated conductor sleeves 100 from front inlet 46 toward the opposite rear inlet 47 (as shown by arrows) while absorbing heat from the stator assembly 16 and conductors/windings 36 for cooling thereof, as shown in FIG. 1. Upon reaching the opposite side of the stator assembly 16, the second portion of coolant passes along the end of windings 36, drains to the sump 84, and is returned to pump 86 to repeat the cycle. It will be appreciated that the described coolant flows may be performed in the opposite direction or in both directions between the opposite ends of the stator/rotor assemblies 16, 18.

Described herein are systems and methods for manufacturing electric machines, such as electric traction motors, with improved cooling. A thermal system is fluidly coupled to the electric machine and configured to provide a flow of coolant in multiple locations to cool the electric machine. One flow of coolant is provided through the rotor shaft, and then through channels in the rotor to the opposite side of rotor. Another flow of coolant is provided to one side of the stator, and then through channels and/or sleeves in the stator to the opposite side of the stator. Accordingly, coolant flow is provided to multiple regions of the electric machine for distributed cooling to quickly and efficiently dissipate heat produced by the electric machine.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present disclosure, its application or uses. Thus, variations that do not depart from the gist of the present disclosure are intended to be within the scope of the present disclosure.

What is claimed is:

1. An electric machine, comprising:
a rotor assembly having a plurality of permanent magnets disposed within a rotor core; and
a stator assembly, comprising:
a stator core with a first end and an opposite second end;
a plurality of radially aligned slots formed in the stator core and defining a plurality of radially aligned teeth;
a sleeve disposed in each slot of the plurality of radially aligned slots; and
conductive windings wound on the plurality of teeth and extending through the sleeves,
wherein a flow of coolant is directed through each sleeve for cooling of the conductive windings between the first and second ends of the stator core.

2. The electric machine of claim 1, wherein each sleeve includes a frame that defines a passage configured to receive the conductive windings and the flow of coolant.

3. The electric machine of claim 2, wherein each sleeve extends an entire axial length of the stator core.

4. The electric machine of claim 2, wherein each sleeve is fabricated from an insulating material configured to electrically separate the conductive windings and the stator core.

5. The electric machine of claim 4, wherein each sleeve is configured to replace insulation paper such that the stator assembly does not include insulation paper wrapped around the conductive windings.

6. The electric machine of claim 1, wherein each sleeve comprises:
a frame that defines a passage configured to receive the conductive windings; and
a plurality of individual coolant conduits extending through the passage,
wherein each individual coolant conduit is configured to receive a portion of the flow of coolant therethrough for cooling the conductive windings extending through the passage.

7. The electric machine of claim 6, wherein each individual coolant conduit is enclosed such that the flow of coolant provides indirect cooling to the conductive windings.

8. The electric machine of claim 6, wherein each individual coolant conduit includes one or more apertures along an axial length thereof, wherein the one or more apertures allow coolant to flow into the passage for direct cooling of the conductive windings.

9. The electric machine of claim 6, wherein each conductive winding includes a pair of the individual coolant conduits disposed on opposite sides of the conductive winding.

10. The electric machine of claim 1, wherein the stator assembly further comprises:
at least one coolant channel formed in each radially aligned tooth,
wherein each coolant channel extends between the stator core first and second ends and is configured to receive at least a portion of the coolant flow.

11. The electric machine of claim 10, wherein the at least one coolant channel includes:
a first rectangular slotted aperture disposed adjacent to the radially aligned slot on a first side of the radially aligned tooth; and
a second rectangular slotted aperture disposed adjacent to the radially aligned slot on an opposite second side of the radially aligned tooth.

12. The electric machine of claim 10, wherein the at least one coolant channel has a first length, and each slot has a second length, wherein the first length is substantially equal to the second length.

13. The electric machine of claim 10, wherein the at least one aperture is an elliptical aperture disposed equidistant between the slots on either side of the radially aligned tooth.

14. The electric machine of claim 1, wherein the rotor assembly further comprises:
a plurality of coolant passages extending between opposite first and second ends of the rotor core and configured to receive a second flow of coolant for cooling of the rotor assembly.

15. The electric machine of claim 14, wherein the coolant passages are arranged circumferentially about an outer diameter of the rotor core.

16. The electric machine of claim 14, wherein the plurality of permanent magnets includes adjacent pairs of permanent magnets oriented in a V-configuration.

17. The electric machine of claim 16, wherein each coolant passage is located centrally of one of the V-configurations radially outward thereof.

18. The electric machine of claim 14, further comprising an output shaft coupled for rotation with the rotor core,
wherein the output shaft includes one or more shaft coolant distribution passages fluidly coupled to the plurality of coolant passages.
